(19) United States
(12) Patent Application Publication
(10) Pub. No.: US 2023/0313855 A1
(43) Pub. Date: Oct. 5, 2023

(54) CALIPER SEAL STRUCTURE

(71) Applicant: HONDA MOTOR CO., LTD., Tokyo (JP)

(72) Inventors: Takatoshi Ebinuma, Tokyo (JP); Yoshihide Nakado, Tokyo (JP); Tomonori Matsuura, Tokyo (JP); Hidekazu Oshima, Tokyo (JP)

(21) Appl. No.: 18/127,026

(22) Filed: Mar. 28, 2023

(30) Foreign Application Priority Data
Mar. 31, 2022 (JP) 2022-061032

(51) Int. Cl. F16D 65/00

(52) U.S. Cl. CPC F16D 65/0068; F16D 2121/04

(57) ABSTRACT

In caliper seal structure, region on one side of caliper main body in axial direction of cylinder with respect to piston seal is set as fluid pressure side where fluid pressure is received, region on other side of caliper main body in axial direction of cylinder with respect to piston seal is set as atmospheric side that opens to atmosphere, and groove forming portion includes holding portion that sets groove width of seal groove in axial direction as first groove width and that is configured to hold piston seal by making inner side surfaces of seal groove in axial direction contact with outer side surfaces of piston seal in axial direction, respectively, and enlarged portion that sets groove width of seal groove in axial direction as second groove width which is increased to one side in axial direction so as to be greater than first groove width.

### CROSS-REFERENCE TO RELATED APPLICATION

Priority is claimed on Japanese Patent Application No. 2022-061032, filed Mar. 31, 2022, the content of which is incorporated herein by reference.

### BACKGROUND OF THE INVENTION

### Field of the Invention

The present invention relates to a caliper seal structure.

### Description of Related Art

In the related art, a structure in which thermal expansion of a piston seal with a trapezoidal cross-sectional shape can be absorbed in a radial direction by fitting the piston seal into a seal groove with a rectangular cross-sectional shape is known (for example, see Japanese Patent No. 4587614). In the configuration, movement of the piston seal in the axial direction is suppressed by causing both outer side surfaces of the piston seal in the axial direction to abut inner side surfaces of the seal groove.

### SUMMARY OF THE INVENTION

However, in the structure in the related art, since sealing is performed on both outer side surfaces of the piston seal in the axial direction, it is difficult for working fluid to reach an outer circumferential side of the piston seal, which may affect movement of the piston.

An aspect of the present invention is directed to providing a caliper seal structure capable of improving movement of a piston while restricting movement of a piston seal in an axial direction.
(1) A caliper seal structure according to an aspect of the present invention includes a caliper main body (3) having a cylinder (5), a piston (6) that is configured to be pressed by a fluid pressure in the cylinder (5), and a piston seal (21) that is configured to hold the piston (6) in the cylinder (5), wherein the caliper main body (3) includes a groove forming portion (11A) that forms an annular seal groove (11) configured to hold the piston seal (21) at an inner circumferential portion of the cylinder (5), a region (R1) on one side of the caliper main body in an axial direction of the cylinder (5) with respect to the piston seal (21) is set as a fluid pressure side where the fluid pressure is received, and a region (R2) on other side of the caliper main body in the axial direction of the cylinder (5) with respect to the piston seal (21) is set as an atmospheric side that is open to the atmosphere, and the groove forming portion (11A) including a holding portion (31) that sets a groove width of the seal groove (11) in the axial direction as a first groove width (H1) and that is configured to hold the piston seal (21) by making inner side surfaces (13, 14) of the seal groove (11) in the axial direction contact with outer side surfaces (23, 24) of the piston seal (21) in the axial direction, respectively; and an enlarged portion (35) that is formed in at least one part of the seal groove (11) in a circumferential direction and that sets a groove width of the seal groove (11) in the axial direction as a second groove width (H2) which is increased to the one side in the axial direction so as to become greater than the first groove width (H1).

According to the configuration of the aspect of the above-mentioned (1), by bringing both the inner side surfaces of the seal groove in the axial direction in contact with both the outer side surfaces of the piston seal in the axial direction, in order to hold the piston seal, no gap is made between the piston seal and the seal groove in the axial direction (sliding direction) of the cylinder and the piston. As a result, it is possible to suppress movement of the piston in the axial direction due to thermal expansion of the piston seal (in particular, return to the fluid pressure side).

Since part of the groove forming portion includes the enlarged portion with an increased groove width at the fluid pressure side additionally to the holding portion that holds the piston seal from both sides in the axial direction, the hydraulic fluid on one side of the piston seal in the axial direction can flow into the piston seal outer circumferential side using the enlarged portion as a communication route. Accordingly, it is possible to suppress sticking of the piston seal outer circumferential side due to expansion of the hydraulic fluid in order to maintain good return of the piston, and to suppress occurrence of a brake drag while improving a brake operation feeling.
(2) In the aspect of the above-mentioned (1), in a cross section crossing the circumferential direction, the seal groove (11) has a cross-sectional shape surrounded by a first side (12a) extending along a bottom surface (12) of the seal groove on an outer circumferential side, a second side (13a) extending along an inner side surface (13) of the seal groove on the one side in the axial direction, a third side (14a) extending along an inner side surface (14) of the seal groove on the other side in the axial direction, and a fourth side (15a) extending along a virtual inner circumferential surface (15) of the seal groove that connects inner circumferential side edges of both the inner side surfaces (13, 14) of the seal groove in the axial direction, and in the cross section crossing the circumferential direction, the piston seal (21) has a cross-sectional shape surrounded by a first side (22a) extending along an outer circumferential surface (22) of the piston seal in contact with the bottom surface (12) of the seal groove (11), a second side (23a) extending along an outer side surface (23) of the piston seal in contact with the inner side surface (13) of the seal groove (11) on the one side in the axial direction, a third side (24a) extending along an outer side surface (24) of the piston seal in contact with the inner side surface (14) of the seal groove (11) on the other side in the axial direction, and a fourth side (25a) extending along an inner circumferential surface (25) of the piston seal in contact with an outer circumferential surface (6a) of the piston (6), and an outer circumferential side chamfer (26) that forms an outer circumferential side space (28) between the outer circumferential side chamfer and the seal groove (11) is formed between at least the first side (22a) and the second side (23a) of the piston seal (21).

According to the configuration of the aspect of the above-mentioned (2), by providing the space between the outer circumferential side of the piston seal and the seal groove, it is possible to absorb thermal expansion of the piston seal without affecting sliding of the piston. By chamfering the outer circumferential side and the fluid pressure side of the cross-sectional shape of the piston seal with respect to the seal groove having a quadrangular cross-sectional shape, it is possible to easily form the space extending over the entire outer circumferential side of the piston seal. Accordingly, it is possible to absorb thermal expansion of the piston seal using a simple structure and suppress sticking of the outer circumferential side of the piston seal.
(3) In the aspect of the above-mentioned (2), a second outer circumferential side chamfer (27) is formed between the first side (22a) and the third side (24a) of the piston seal (21), the second outer circumferential side chamfer (27) forming a second outer circumferential side space (29) between the second outer circumferential side chamfer and the seal groove (11).

According to the configuration of the aspect of the above-mentioned (3), since the space is provided between the outer circumferential side of the piston seal and the seal groove even on the other side of the piston seal in the axial direction, it is possible to more easily absorb thermal expansion of the piston seal.
(4) In the aspect of any one of the above-mentioned (1) to (3), the enlarged portion (35) is formed by making a recess in a part of the groove forming portion (11A) on the one side in the axial direction along a reference line (C2) extending obliquely from a center axis side of the cylinder (5), and an extension part of the reference line (C2) on the other side in the axial direction is set so as to pass inside of an opening portion (5c) of the cylinder (5) on the other side in the axial direction.

According to the configuration of the aspect of the above-mentioned (4), the enlarged portion on one side of the groove forming portion in the axial direction is formed by making a recess in the groove forming portion in the extension direction of the reference line extending obliquely from a center axis side of the cylinder. The enlarged portion can be formed by inserting a machining tool into the cylinder in a direction along the reference line and drilling the recess in the groove forming portion. Since the extension part on the other side of the reference line in the axial direction passes inside of the opening portion of the cylinder, the machining tool can be inserted from the opening portion of the cylinder to facilitate machining (forming) of the enlarged portion. In this way, processability of the enlarged portion that expands the seal groove can be improved.
(5) In the aspect of the above-mentioned (4), the enlarged portion (35) is formed in a circular shape when seen in a direction along the reference line (C2), and a virtual cylinder (K2) formed by extending the circular shape in the direction along the reference line (C2) when the enlarged portion (35) is seen in the direction along the reference line (C2) is set to pass inside of the opening portion (5c) of the cylinder (5) entirely.

According to the configuration of the aspect of the above-mentioned (5), since the extension part with the maximum diameter of the circular shape of the enlarged portion is set to pass inside of the opening portion of the cylinder, the machining tool is easily inserted from the opening portion of the cylinder, and processability of the enlarged portion can be further improved.
(6) In the aspect of the above-mentioned (5), the caliper main body (3) includes an arm portion (7) configured to support a brake pad (Pa) on the other side in the axial direction with respect to the opening portion (5c), and the virtual cylinder (K2) is set so as to avoid the arm portion (7).

According to the configuration of the aspect of the above-mentioned (6), since the extension part with the maximum diameter of the circular shape of the enlarged portion is set to extend so as to avoid the arm portion that supports the brake pad in the caliper main body, the machining tool is more easily inserted toward the enlarged portion, and processability of the enlarged portion can be further improved.

According to the aspect of the present invention, it is possible to provide a caliper seal structure capable of improving movement of a piston while restricting movement of a piston seal in an axial direction.

### BRIEF DESCRIPTION OF THE DRAWINGS

FIG. 1 is a cross-sectional view showing a caliper according to an embodiment of the present invention in a cylinder axial direction.

FIG. 2 is an enlarged view of a portion II of FIG. 1, showing a basic cross section perpendicular to a circumferential direction of a seal groove and a piston seal.

FIG. 3 is an enlarged view corresponding to FIG. 2, showing a slit formed in an outer circumferential portion of the piston seal.

FIG. 4 is a side view when a caliper main body is seen in a cylinder axial direction, showing a machining tool overlapping an enlarged portion of the seal groove.

FIG. 5 is a cross-sectional view along line V-V of FIG. 4, showing the machining tool overlapping the enlarged portion.

### DETAILED DESCRIPTION OF THE INVENTION

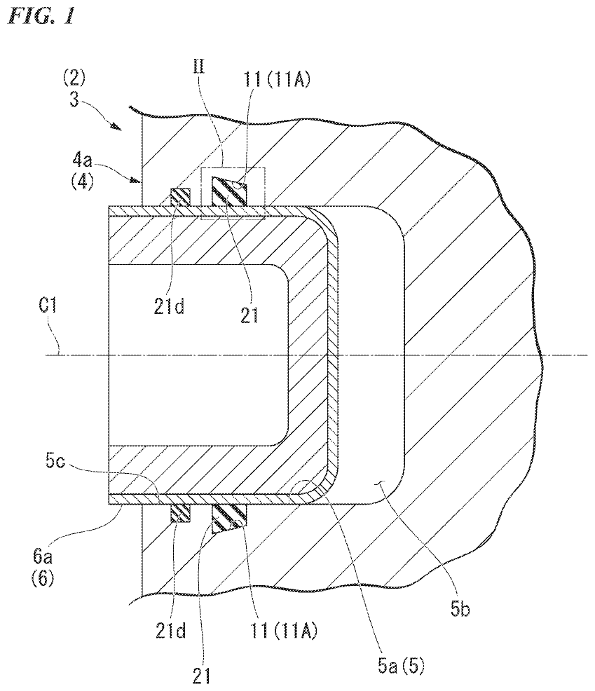

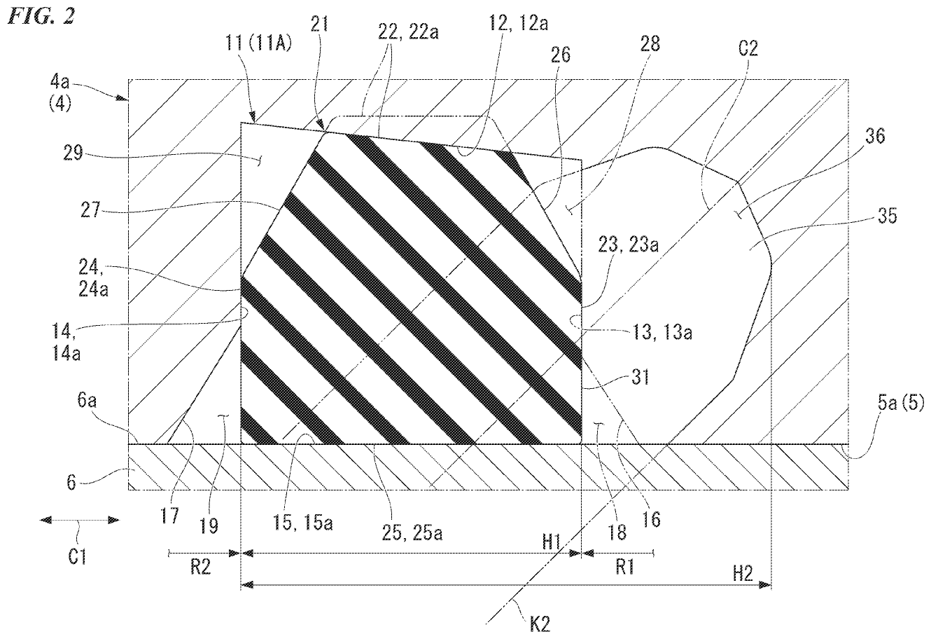

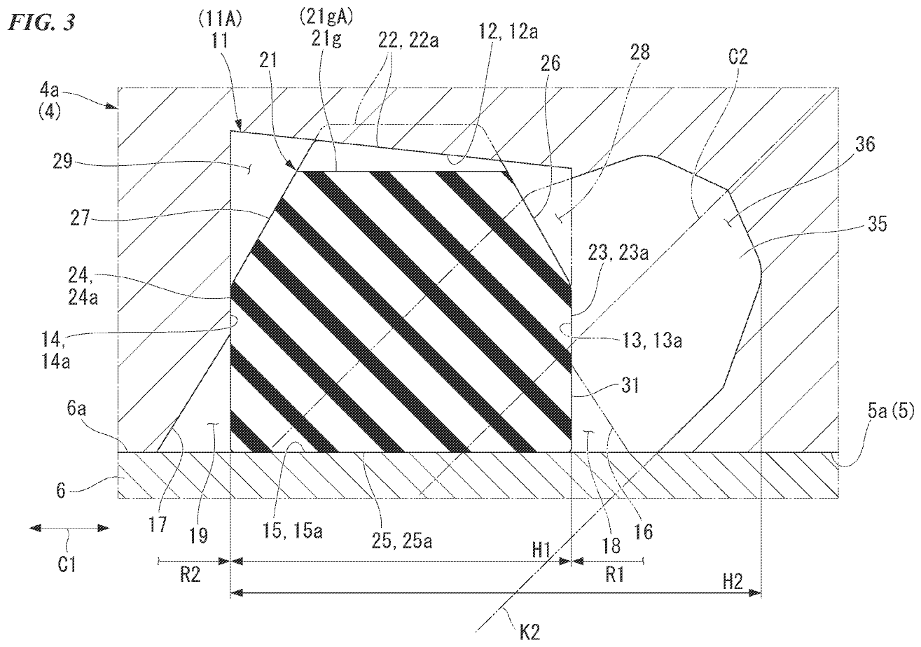

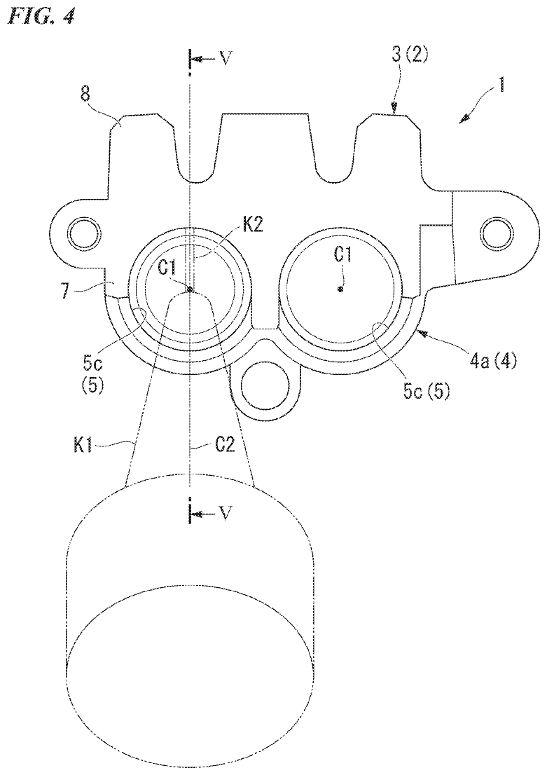

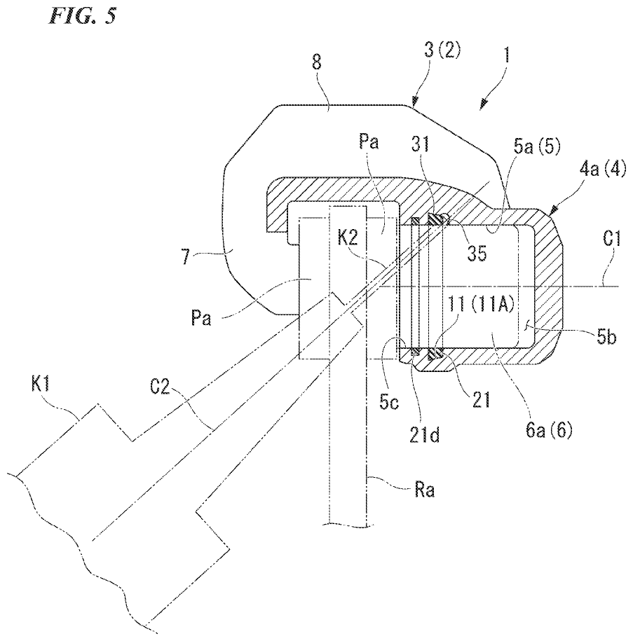

Hereinafter, an embodiment of the present invention will be described with reference to the accompanying drawings. FIG. 1 is a cross-sectional view of a cylinder of a caliper 2 of the embodiment in an axial direction. FIG. 2 is an enlarged view of a major part of FIG. 1, showing a cross section perpendicular to a seal groove 11 and a piston seal 21 in a circumferential direction. FIG. 3 is an enlarged view of a major part showing a variant of FIG. 2. FIG. 4 is a side view when a caliper main body 3 is seen in the axial direction of the cylinder 5, showing a machining tool K1 overlapping an enlarged portion 35. FIG. 5 is a cross-sectional view along line V-V of FIG. 4, showing the machining tool K1 overlapping the enlarged portion 35.

### <Caliper Structure>

Referring to FIG. 5, the caliper 2 of the embodiment is used in a hydraulically operated disk brake 1. The caliper 2 is a so-called one-sided push type, and includes a hydraulic working part 4 having the cylinder 5 and a piston 6, an arm portion 7 disposed with respect to the hydraulic working part 4 at an interval in an axial direction of the cylinder 5, and a bridge portion 8 configured to connect the arm portion 7 and the hydraulic working part 4 to each other. A brake rotor Ra and a pair of brake pads Pa that sandwiches the brake rotor Ra are disposed between the hydraulic working part 4 and the arm portion 7.

The axial direction of the cylinder 5 and the piston 6 is parallel to the axial direction of the brake rotor Ra. A line C1 in the drawing shows a center axis of the cylinder 5 and the piston 6. Hereinafter, the axial direction is referred to as a direction of an axis C1. For the convenience of illustration, the direction of the axis C1 is shown by an arrow C1.

The cylinder 5 has a bottomed cylindrical shape in which one side in the direction of the axis C1 (a right side in the drawing) is closed. The cylinder 5 has an end portion in the direction of the axis C1 on the other side (a left side in the drawing), which is an opening portion 5c. The piston 6 is inserted into the cylinder 5 from the opening portion 5c. Since the other side of the cylinder 5 in the direction of the axis C1 is closed by the piston 6, an oil chamber 5b is formed on one side of the cylinder 5 in the direction of the axis C1.

A brake fluid (working fluid, hydraulic fluid) can be supplied into the oil chamber 5b from a master cylinder (not shown). When the brake fluid in the oil chamber 5b is pressurized by an action of the master cylinder (i.e., when a hydraulic pressure is supplied), the piston 6 is displaced toward the other side in the direction of the axis C1, and the brake pads Pa on the side of the hydraulic working part 4 are pressed toward the brake rotor Ra. The caliper 2 is displaced toward one side in the direction of the axis C1 by the pressing reaction, and the arm portion 7 presses the brake pads Pa on the side of the arm portion 7 toward the brake rotor Ra. As a result, the caliper 2 clamps the brake rotor Ra using the pair of brake pads Pa, and brakes the brake rotor Ra and a wheel.

### <Seal Structure>

Referring to FIG. 1 and FIG. 2, the piston 6 is held in the cylinder 5 via the annular piston seal 21. The piston seal 21 is fitted and held in the annular seal groove 11 formed in an inner circumferential portion of the cylinder 5. The piston seal 21 forms a quadrangular cross-sectional shape and extends with a fixed cross section in a circumferential direction except a slit forming portion 21gA, which will be described below. The seal groove 11 forms a quadrangular cross-sectional shape and extends with a fixed cross section in the circumferential direction except the enlarged portion 35, which will be described below. The piston seal 21 and the seal groove 11 are formed coaxially with an outer circumferential surface 6a of the piston 6 and an inner circumferential surface 5a of the cylinder 5 (in a concentric circular shape). A part of the inner circumferential portion of the cylinder 5 that forms the seal groove 11 is referred to as a groove forming portion 11A.

An inner circumferential surface 25 of the piston seal 21 comes in contact with the outer circumferential surface 6a having a cylindrical shape in the piston 6. The piston seal 21 is formed of an elastic material such as synthetic rubber or the like, and when a hydraulic pressure in the oil chamber 5b is increased and the piston 6 moves (advances) to the other side in the direction of the axis C1, movement of the piston 6 is allowed while being elastically deformed. The piston seal 21 returns (retreats) the piston 6 to the position before movement by recovering the elastic deformation when the hydraulic pressure of the oil chamber 5b is released and returns to correspond to the atmospheric pressure.

When the brake pads Pa are worn and an advance amount of the piston 6 is increased, sliding occurs between the piston seal 21 and the piston 6, and an elastic deformation amount of the piston seal 21 and a retreat amount of the piston 6 are kept constant. A dust seal 21d configured to prevent intrusion of foreign substances into the cylinder 5 is disposed on the other side of the piston seal 21 in the direction of the axis C1. A gap (space) configured to absorb thermal expansion of the piston seal 21 is formed between an outer circumferential side of the piston seal 21 and an outer circumferential side of the seal groove 11. The gap includes a first outer circumferential side space 28 on one side in the direction of the axis C1, and a second outer circumferential side space 29 on the other side in the direction of the axis C1.

Referring also to FIG. 5, the caliper main body 3 that is an integrated structure in the caliper 2 includes the cylinder 5 having a bottomed cylindrical shape. The caliper main body 3 includes a housing 4a of the hydraulic working part 4, the arm portion 7, and the bridge portion 8 configured to connect the arm portion 7 and the housing 4a to each other.

### <Seal Groove and Piston Seal>

Referring to FIG. 2, shapes of cross sections (cross-sectional shapes) of the annular seal groove 11 and the piston seal 21 perpendicular to the circumferential direction will be described.

The cross-sectional shape of the seal groove 11 is a quadrangular shape. The seal groove 11 is surrounded by a first side 12a extending along a bottom surface 12 of the seal groove 11 on an outer circumferential side, a second side 13a extending along an inner side surface 13 of the seal groove 11 on one side in the direction of the axis C1, a third side 14a extending along an inner side surface 14 of the seal groove 11 on the other side in the direction of the axis C1, and a fourth side 15a extending along a virtual inner circumferential surface 15 of the seal groove 11 that connects inner circumferential side edges of both the inner side surfaces 13 and 14 of the seal groove 11 in the direction of the axis C1. The bottom surface 12 is a tapered surface expanding toward the other side in the direction of the axis C1 (corresponding to an outer circumferential surface of a truncated cone). Both the inner side surfaces 13 and 14 in the direction of the axis C1 are flat surfaces perpendicular to the direction of the axis C1, respectively, and the inner circumferential surface 15 is a cylindrical surface extending in the direction of the axis C1.

In the groove forming portion 11A, a first inner circumferential side flat chamfer 16 is formed between the inner side surface 13 on one side of the seal groove 11 in the direction of the axis C1 and the inner circumferential surface 5a on one side of the seal groove 11 in the cylinder 5 in the direction of the axis C1. Since the first inner circumferential side flat chamfer 16 is formed on the groove forming portion 11A, a first inner circumferential side space 18 having a triangular cross section is formed on an inner circumferential side of the seal groove 11 and on one side in the direction of the axis C1.

In the groove forming portion 11A, a second inner circumferential side flat chamfer 17 is formed between the inner side surface 14 of the seal groove 11 on the other side in the direction of the axis C1 and the inner circumferential surface 5a of the cylinder 5 on the other side in the direction of the axis C1 with respect to the seal groove 11. Since the second inner circumferential side flat chamfer 17 is formed on the groove forming portion 11A, a second inner circumferential side space 19 having a triangular cross section is formed on an inner circumferential side of the seal groove 11 and on the other side in the direction of the axis C1.

A region R1 of the cylinder 5 on one side in the direction of the axis C1 with respect to the piston seal 21 serves as a hydraulic pressure side where the hydraulic pressure is received, and a region R2 of the cylinder 5 on the other side in the direction of the axis C1 with respect to the piston seal 21 serves as an atmospheric side that opens to the atmosphere.

The cross-sectional shape of the piston seal 21 is surrounded by a first side 22a extending along an outer circumferential surface 22 of the piston seal 21 that contacts with the bottom surface 12 of the seal groove 11 on the outer circumferential side, a second side 23a extending along an outer side surface 23 of the piston seal 21 that contacts with the inner side surface 13 of the seal groove 11 on one side in the direction of the axis C1, a third side 24a extending along an outer side surface 24 of the piston seal 21 that contacts with the inner side surface 14 of the seal groove 11 on the other side in the direction of the axis C1, and a fourth side 25a extending along the inner circumferential surface 25 of the piston seal 21 that connects inner circumferential side edges of both the outer side surfaces 23 and 24 of the piston seal 21 in the direction of the axis C1. The outer circumferential surface 22 is a cylindrical surface extending in the direction of the axis C1 and a seal surface that is applied to the bottom surface 12 of the seal groove 11. The outer circumferential surface 22 is deformed (displaced) by pressing the outer circumferential portion of the piston seal 21 against the bottom surface 12 of the seal groove 11. A dotted line in the drawing shows a shape before the piston seal 21 is elastically deformed. Both the outer side surfaces 23 and 24 in the direction of the axis C1 are flat surfaces perpendicular to the direction of the axis C1, and are seal surfaces that contacts with both the inner side surfaces 13 and 14 of the seal groove 11, respectively. The inner circumferential surface 25 is a cylindrical surface extending in the direction of the axis C1 and is a seal surface that contacts with the outer circumferential surface 6a of the piston 6.

A first outer circumferential side flat chamfer 26 is formed between the outer circumferential surface 22 and the outer side surface 23 on one side in the direction of the axis C1 of the piston seal 21. Since the first outer circumferential side flat chamfer 26 is formed in the piston seal 21, the first outer circumferential side space 28 having a triangular cross section is formed between the seal groove 11 and the piston seal 21 on the outer circumferential side of the piston seal 21 and on one side in the direction of the axis C1.

A second outer circumferential side flat chamfer 27 is formed between the outer circumferential surface 22 and the outer side surface 24 on the other side in the direction of the axis C1 of the piston seal 21. Since the second outer circumferential side flat chamfer 27 is formed on the piston seal 21, the second outer circumferential side space 29 having a triangular cross section is formed between the seal groove 11 and the piston seal 21 on the outer circumferential side of the piston seal 21 and on the other side in the direction of the axis C1.

Since the first outer circumferential side flat chamfer 26 and the second outer circumferential side flat chamfer 27 are formed in the piston seal 21, a cross-sectional shape of the piston seal 21 on the outer circumferential side is a trapezoidal shape.

The width of the piston seal 21 in the direction of the axis C1 and the width (groove width) of the seal groove 11 in the direction of the axis C1 are substantially the same as each other, or the width of the seal groove 11 is slightly smaller than that of the piston seal 21. As a result, expansion of the piston seal 21 in the direction of the axis C1 is suppressed, and movement of the piston seal 21 in the direction of the axis C1 according to the expansion is restricted. Accordingly, properties (in particular, plays) of the brake can be stabilized even upon an increase in temperature.

By chamfering the corner of the piston seal 21 on the outer circumferential side, a gap (space) is formed on the outer circumferential side not in contact with the piston 6 in the piston seal 21. Accordingly, an expansion portion of the piston seal 21 upon an increase in temperature can be released into the space.

By chamfering the corner of the piston seal 21 on the outer circumferential side, it also has the effect of making it difficult to catch the piston seal 21 when being fitted into the seal groove 11 and facilitating assembly of the piston seal 21.

Further, the cylinder 5 (the caliper main body 3) and the piston 6 are formed of a metal such as aluminum alloy, and have smaller deformation due to thermal expansion than that of the piston seal 21 formed of rubber.

The groove forming portion 11A includes a holding portion 31 configured to hold the piston seal 21 by setting the groove width of the seal groove 11 in the direction of the axis C1 as a first groove width H1, and the enlarged portion 35 that is formed in at least one part of the seal groove 11 in the circumferential direction (one place in the embodiment) and that sets the groove width of the seal groove 11 in the direction of the axis C1 as a second groove width H2 which is greater than the first groove width H1.

The holding portion 31 holds the piston seal 21 in a state in which movement in the direction of the axis C1 is restricted by bringing both the inner side surfaces 13 and 14 of the seal groove 11 in the direction of the axis C1 in contact with both the outer side surfaces 23 and 24 of the piston seal 21 in the direction of the axis C1, respectively.

The enlarged portion 35 is recessed on one side of the seal groove 11 in the direction of the axis C1 so as to cut out the inner side surface 13 (seal surface) on the same side. The enlarged portion 35 expands the groove width of the seal groove 11 in the direction of the axis C1 so as to widen on one side in the direction of the axis C1. A concave space 36 formed in the enlarged portion 35 brings an inner circumferential side space 18 and an outer circumferential side space 28 in communication with each other on one side of the seal groove 11 in the direction of the axis C1. In the enlarged portion 35, the brake fluid in the cylinder 5 reaches the outer circumferential side space 28 on one side in the direction of the axis C1 via the inner circumferential side space 18 and the concave space 36, and further reaches an outer circumferential side space 29 on the other side in the direction of the axis C1 via a slit 22g.

Even in the configuration in which the piston seal 21 contacts with (is sealed by) one side of the seal groove 11 in the direction of the axis C1, the brake fluid can reach the outer circumferential side of the seal groove 11. It is possible to suppress the sticking of the outer circumferential side of the piston seal 21, maintain good return of the piston 6 (and thus the stability of the operation), and improve the brake operation feeling. The brake fluid that reaches the outer circumferential side of the seal groove 11 is sealed on the outer circumferential surface 22 of the piston seal 21 and the outer side surface 24 of the other side in the direction of the axis C1, and a leakage to the atmospheric side is suppressed.

Referring to FIG. 3, a slit (communication route) 21g as a semi-circular groove extending in the direction of the axis C1 is formed in the outer circumferential portion of the piston seal 21 by cutting out the upper surface (outer circumferential surface) on at least one place (in the embodiment, one place corresponding to the enlarged portion 35) in the circumferential direction. The slit 21g brings both side spaces on the outer circumferential side of the seal groove 11 in the direction of the axis C1 in communication with each other. The brake fluid that reaches the first outer circumferential side space 28 of the seal groove 11 on one side in the direction of the axis C1 reaches the second outer circumferential side space 29 on the other side in the direction of the axis C1 via the slit 21g. Accordingly, the sticking of the outer circumferential side of the piston seal 21 is more reliably suppressed, and the return of the piston 6 (and thus the stability of the operation) is more reliably improved. The brake fluid that reaches the second outer circumferential side space 29 on the other side in the direction of the axis C1 is sealed on the outer side surface 24 of the piston seal 21 on the other side in the direction of the axis C1, and a leakage to the atmospheric side is suppressed. A part in which the slit 21g in the inner circumferential portion of the piston seal 21 is formed is referred to as the slit forming portion 21gA.

Referring to FIG. 2 and FIG. 3, the enlarged portion 35 becomes a concave portion that forms an inner surface having a bottomed cylindrical shape. The enlarged portion 35 is formed using the following reference line C2 as a center axis. The reference line C2 is a straight line extending diagonally with respect to the center axis C1 of the cylinder 5 from a center axis C1 side of the cylinder 5 toward a part of the groove forming portion 11A in the circumferential direction (an area that forms the enlarged portion 35).

Referring to FIG. 4, for example, the reference line C2 crosses the center axis C1 of the cylinder 5. When seen in the direction of the axis C1 of the cylinder 5, the reference line C2 vertically crosses an area that forms the enlarged portion 35 in the groove forming portion 11A.

Referring to FIG. 2 to FIG. 5, the enlarged portion 35 is drilled from a direction along the reference line C2 using a rotating tool such as a drill, an end mill, or the like. The enlarged portion 35 is formed in a substantially circular shape when seen in a direction along the reference line C2. However, the enlarged portion 35 does not necessarily look like a circular shape because it is cut out at the seal groove 11. In the case of the embodiment, the cylindrical portion of the enlarged portion 35 is cut out on the outer circumferential side of the seal groove 11. Meanwhile, since there is a residual cylindrical portion of the enlarged portion 35, a virtual circular shape centered on the reference line C2 is recognized. By setting the circular shape as a maximum radius of the enlarged portion 35 and extending it along the reference line C2, a virtual cylinder K2 that defines the space required for the mechanical working of the enlarged portion 35 is formed. An extension part of the reference line C2 and the virtual cylinder K2 on the other side in the direction of the axis C1 passes inside of the opening portion 5c of the cylinder 5.

That is, an edge of a rotating tool such as a drill, an end mill, or the like, can reach an area that forms the enlarged portion 35 in the groove forming portion 11A through the opening portion 5c of the cylinder 5. Further, the extension part of the reference line C2 and the virtual cylinder K2 on the other side in the direction of the axis C1 avoids the arm portion 7 of the caliper main body 3 (see FIG. 5), which also enables mechanical working by a simple linear motion of the enlarged portion 35. The enlarged portion 35 may be formed not only by the linear mechanical working, but also various machining such as electro-discharging machining, machining with an angle head, or the like. In this case, the enlarged portion 35 is not limited to a configuration that is obliquely recessed along the reference line C2, and for example, may be a groove that extending along the inner side surface 13 of the seal groove 11 on one side in the direction of the axis C1 at a constant cross section, or the like.

As described above, the caliper seal structure according to the embodiment includes the caliper main body 3 having the cylinder 5, the piston 6 that is configured to be pressed by a fluid pressure in the cylinder 5, and the piston seal 21 that is configured to hold the piston 6 in the cylinder 5, wherein the caliper main body 3 includes the groove forming portion 11A that forms the annular seal groove 11 configured to hold the piston seal 21 at the inner circumferential portion of the cylinder 5, the region R1 on one side of the caliper main body in the direction of the axis C1 of the cylinder 5 with respect to the piston seal 21 is set as a fluid pressure side where the fluid pressure is received, the region R2 on other side of the caliper main body in the direction of the axis C1 of the cylinder 5 with respect to the piston seal 21 is set as an atmospheric side that opens to the atmosphere, and the groove forming portion 11A includes the holding portion 31 that sets the groove width of the seal groove 11 in the direction of the axis C1 as the first groove width H1 and that is configured to hold the piston seal 21 by making the inner side surfaces 13 and 14 of the seal groove 11 in the direction of the axis C1 contact with the outer side surfaces 23 and 24 of the piston seal 21 in the direction of the axis C1, respectively, and the enlarged portion 35 that is formed on at least one part of the seal groove 11 in the circumferential direction and that sets the groove width of the seal groove 11 in the direction of the axis C1 as the second groove width H2 which is increased to the one side in the direction of the axis C1 so as to become greater than the first groove width H1.

According to the configuration, by bringing both the inner side surfaces 13 and 14 of the seal groove 11 in the direction of the axis C1 in contact with both the outer side surfaces 23 and 24 of the piston seal 21 in the direction of the axis C1, in order to hold the piston seal 21, no gap is made between the piston seal 21 and the seal groove 11 of the cylinder 5 and the piston 6 in the direction of the axis C1 (sliding direction). As a result, it is possible to suppress the piston 6 from moving in the direction of the axis C1 (in particular, pressing back to the fluid pressure side) due to thermal expansion of the piston seal 21.

Since the groove forming portion 11A partially includes the enlarged portion 35 with an increased groove width at the fluid pressure side additionally to the holding portion 31 that holds the piston seal 21 from both sides in the direction of the axis C1, the hydraulic fluid on one side of the piston seal 21 in the direction of the axis C1 can flow into the piston seal 21 on the outer circumferential side using the enlarged portion 35 as the communication route. Accordingly, it is possible to suppress sticking of the outer circumferential side of the piston seal 21 due to expansion of the hydraulic fluid and maintain good return of the piston 6, and suppress occurrence of a brake drag while improving brake operation feeling.

In addition, in the caliper seal structure, in a cross section crossing the circumferential direction, the seal groove 11 has a cross-sectional shape surrounded by the first side 12a extending along the bottom surface 12 of the seal groove on the outer circumferential side, the second side 13a extending along an inner side surface 13 of the seal groove on the one side in the direction of the axis C1, the third side 14a extending along an inner side surface 14 of the seal groove on the other side in the direction of the axis C1, and the fourth side 15a extending along the virtual inner circumferential surface 15 of the seal groove that connects the inner circumferential side edges of both the inner side surfaces 13 and 14 of the seal groove in the direction of the axis C1, in the cross section crossing the circumferential direction, the piston seal 21 has a cross-sectional shape surrounded by the first side 22a extending along the outer circumferential surface 22 of the piston seal in contact with the bottom surface 12 of the seal groove 11, the second side 23a extending along the outer side surface 23 of the piston seal in contact with the inner side surface 13 of the seal groove 11 on the one side in the direction of the axis C1, the third side 24a extending along the outer side surface 24 of the piston seal in contact with the inner side surface 14 of the seal groove 11 on the other side in the direction of the axis C1, and the fourth side 25a extending along the inner circumferential surface 25 of the piston seal in contact with the outer circumferential surface 6a of the piston 6, and the first outer circumferential side flat chamfer 26 that forms the first outer circumferential side space 28 between the first outer circumferential side flat chamfer 26 and the seal groove 11 is formed between at least the first side 22a and the second side 23a of the piston seal 21.

According to the configuration, by providing the space between the outer circumferential side of the piston seal 21 and the seal groove 11, thermal expansion of the piston seal 21 can be absorbed without affecting the sliding of the piston 6.

By chamfering the outer circumferential side and the fluid pressure side of the cross-sectional shape of the piston seal 21 with respect to the seal groove 11 having the quadrangular cross-sectional shape, it is possible to easily form the space extending over the entire outer circumferential side of the piston seal 21. Accordingly, it is possible to absorb thermal expansion of the piston seal 21 using a simple structure and suppress sticking of the outer circumferential side of the piston seal 21.

In addition, in the caliper seal structure, the second outer circumferential side flat chamfer 27 is formed between the first side 22a and the third side 24a of the piston seal 21, the second outer circumferential side flat chamfer 27 forming the second outer circumferential side space 29 between the second outer circumferential side flat chamfer 27 and the seal groove 11.

According to the configuration, by forming the space between the outer circumferential side of the piston seal 21 and the seal groove 11 even on the other side in the direction of the axis C1 of the piston seal 21, thermal expansion of the piston seal 21 can be more easily absorbed.

Further, since the slit 21g configured to bring the first outer circumferential side space 28 and the second outer circumferential side space 29 in communication with each other is formed in the first side 22a of the piston seal 21, thermal expansion of the piston seal 21 can be more easily absorbed on the outer circumferential side of the piston seal 21.

In addition, in the caliper seal structure, the enlarged portion 35 is formed by making a recess in a part of the groove forming portion 11A on the one side in the direction of the axis C1 along the reference line C2 extending obliquely from the center axis C1 side of the cylinder 5, and the extension part of the reference line C2 on the other side in the direction of the axis C1 is set so as to pass inside of the opening portion 5c of the cylinder 5 on the other side in the direction of the axis C1.

According to the configuration, the enlarged portion 35 on one side of the groove forming portion 11A in the direction of the axis C1 is formed by making a recess on the groove forming portion 11A in the extension direction of the reference line C2 extending obliquely from the center axis C1 side of the cylinder 5. The enlarged portion 35 can be formed by inserting the machining tool K1 into the cylinder 5 in the direction along the reference line C2 and drilling a recess in the groove forming portion 11A. Since the extension part on the other side of the reference line C2 in the direction of the axis C1 passes inside of the opening portion 5c of the cylinder 5, the machining tool K1 is inserted from the opening portion 5c of the cylinder 5 to facilitate machining (forming) of the enlarged portion 35. In this way, processability of the enlarged portion 35 that expands the seal groove 11 can be improved.

In addition, in the caliper seal structure, the enlarged portion 35 is formed in a circular shape when seen in the direction along the reference line C2, and the virtual cylinder K2 formed by extending the circular shape in the direction along the reference line C2 when the enlarged portion 35 is seen in the direction along the reference line C2 is set to pass inside of the opening portion 5c of the cylinder 5 entirely.

According to the configuration, since the extension part with the maximum diameter of the circular shape of the enlarged portion 35 is set to pass inside of the opening portion 5c of the cylinder 5, the machining tool K1 is easily inserted from the opening portion 5c of the cylinder 5, and processability of the enlarged portion 35 can be further improved.

In addition, in the caliper seal structure, the caliper main body 3 includes the arm portion 7 configured to support the brake pads Pa on the other side in the direction of the axis C1 with respect to the opening portion 5c, and the virtual cylinder K2 is set so as to avoid the arm portion 7.

According to the configuration, since the extension part with the maximum diameter of the circular shape of the enlarged portion 35 is set so as to avoid the arm portion 7 that supports the brake pads Pa in the caliper main body 3, the machining tool K1 is more easily inserted toward the enlarged portion 35, and processability of the enlarged portion 35 can be further improved.

Further, the present invention is not limited to the embodiment, and for example, the enlarged portion 35 of the seal groove 11 is not limited to one place and may be provided at a plurality of places. The caliper 2 is not limited to two pots (two pistons) but may be one pot or three pots. The caliper 2 is not limited to a single-push type and may be a facing type (both-push type).

Then, the configuration according to the embodiment is an example of the present invention, and various modifications may be made without departing from the scope of the present invention by substituting the components of the embodiment with known components.

What is claimed is:

1. A caliper seal structure comprising:
a caliper main body having a cylinder;
a piston that is configured to be pressed by a fluid pressure in the cylinder; and
a piston seal that is configured to hold the piston in the cylinder,
wherein the caliper main body includes a groove forming portion that forms an annular seal groove configured to hold the piston seal at an inner circumferential portion of the cylinder,
wherein a region on one side of the caliper main body in an axial direction of the cylinder with respect to the piston seal is set as a fluid pressure side where the fluid pressure is received, and a region on other side of the caliper main body in the axial direction of the cylinder with respect to the piston seal is set as an atmospheric side that is open to the atmosphere, and
the groove forming portion includes:
a holding portion that sets a groove width of the seal groove in the axial direction as a first groove width and that is configured to hold the piston seal by making inner side surfaces of the seal groove in the axial direction contact with outer side surfaces of the piston seal in the axial direction, respectively; and
an enlarged portion that is formed in at least one part of the seal groove in a circumferential direction and that sets a groove width of the seal groove in the axial direction as a second groove width which is increased to the one side in the axial direction so as to become greater than the first groove width.

2. The caliper seal structure according to claim 1, wherein, in a cross section crossing the circumferential direction, the seal groove has a cross-sectional shape surrounded by a first side extending along a bottom surface of the seal groove on an outer circumferential side, a second side extending along an inner side surface of the seal groove on the one side in the axial direction, a third side extending along an inner side surface of the seal groove on the other side in the axial direction, and a fourth side extending along a virtual inner circumferential surface of the seal groove that connects inner circumferential side edges of both the inner side surfaces of the seal groove in the axial direction, and
in a cross section crossing the circumferential direction, the piston seal has a cross-sectional shape surrounded by a first side extending along an outer circumferential surface of the piston seal in contact with the bottom surface of the seal groove, a second side extending along an outer side surface of the piston seal in contact with the inner side surface of the seal groove on the one side in the axial direction, a third side extending along an outer side surface of the piston seal in contact with the inner side surface of the seal groove on the other side in the axial direction, and a fourth side extending along an inner circumferential surface of the piston seal in contact with an outer circumferential surface of the piston, and
an outer circumferential side chamfer that forms an outer circumferential side space between the outer circumferential side chamfer and the seal groove is formed between at least the first side and the second side of the piston seal.

3. The caliper seal structure according to claim 2, wherein a second outer circumferential side chamfer is formed between the first side and the third side of the piston seal, the second outer circumferential side chamfer forming a second outer circumferential side space between the second outer circumferential side chamfer and the seal groove.

4. The caliper seal structure according to claim 1, wherein the enlarged portion is formed by making a recess in a part of the groove forming portion on the one side in the axial direction along a reference line extending obliquely from a center axis side of the cylinder, and
an extension part of the reference line on the other side in the axial direction is set so as to pass inside of an opening portion of the cylinder on the other side in the axial direction.

5. The caliper seal structure according to claim 4, wherein the enlarged portion is formed in a circular shape when seen in a direction along the reference line, and a virtual cylinder formed by extending the circular shape in the direction along the reference line when the enlarged portion is seen in the direction along the reference line is set to pass inside of the opening portion of the cylinder entirely.

6. The caliper seal structure according to claim 5, wherein the caliper main body includes an arm portion configured to support a brake pad on the other side in the axial direction with respect to the opening portion, and
the virtual cylinder is set so as to avoid the arm portion.
